(19) United States
(12) Patent Application Publication
(10) Pub. No.: US 2002/0006875 A1
(43) Pub. Date: Jan. 17, 2002

(54) Room temperature superconductor

(76) Inventor: Grant T. Mcfetridge, Grass Valley, CA (US)

Correspondence Address: SMITH-HILL AND BEDELL, 12670 N W BARNES ROAD, SUITE 104, PORTLAND, OR, 97229

(21) Appl. No.: 09/766,012

(22) Filed: Jan. 18, 2001

Related U.S. Application Data
(60) Provisional application No. 60/178,244, filed on Jan. 20, 2000.

(51) Int. Cl. H01F 1/00

(52) U.S. Cl. 505/110

(57) ABSTRACT

Superconductors (or superconducting magnets) that exist at temperature ranges above to below room temperature.

### CROSS-REFERENCE TO RELATED APPLICATION

This application claims benefit of Provisional Application No. 60/178,244 filed Jan. 20, 2000.

The invention is in two parts:

1) A method to identify materials or the particular structure of materials in a variety of environmental conditions, such as temperature, pressure, electrical, magnetic or nuclear environments that potentially can be used to create superconductors. The novel use of these materials is as a superconductor, especially but not exclusively as superconductors in the range of room temperatures.

The essential insight of this patent is that any material that exhibits any sort of magnetic effects does so because the material is in a superconducting state carrying current in an internal loop. In standard substances, this means that the magnetic domain walls in the material are in a superconducting state. Thus, we can identify any potential superconductor because it exhibits magnetic action under ranges of environmental conditions, such as temperature, pressure, and so on. The most familiar example of a material that exhibits room temperature superconducting is the common household permanent magnet.

The second part is:

2) Processes to change existing material or manufacture the material so it can be used as a superconductor or superconducting magnet. The novel use of materials fabricated or changed in this way is as superconducting material.

In essence any manufacturing process that can take the chemical or organic substances in the magnetic materials domain walls, and put it into the molecular or atomic configuration that the domain walls had can be used to make an electrical superconducting material. It would be a superconductor over a similar temperature range that the original magnet exhibited magnetism. We include all variations to the process by doping with other elements or compounds, which also can be used to vary other mechanical and electrical characteristics, such as strength, flexibility, or current carrying capability. We also include the manufacturing of materials with superconducting structures in them, for example a material with superconducting filaments in them, which might be used to change other mechanical, electrical or magnetic properties.

The superconducting effect may be necessary to induce in the material, even though it has the correct molecular or atomic arrangement. Currently, it is the simplest to do with applied electrical energy, but it might be done through other means such as pressure or magnetic fields, or doping with certain additives, during or after manufacturing, or combinations thereof. Thus, the preferred way to create superconduction is using electrical means because it is the simplest way at this time for us to create the product. This does not mean that it is the preferred choice in all circumstances of manufacturing or use, due to tradeoffs in cost, current carrying capabilities, size, temperature range, mechanical and physical properties, and manufacturing simplicity. Additionally, a range of options for inducing the superconducting effect exist, and optimum values vary with material.

We reserve the right to exploit all the variations in material and manufacturing in producing the superconductor effect. In addition, we reserve the rights on using these superconducting products in the creation of permanent, semi permanent, and temporary magnetic fields. And we reserve the rights on using these superconductor devices as heat conduction devices. Additionally, we include all physical manifestations of the superconductors, from wire, to fixed or flexible structures and geometrical configurations, or to structures that have superconductor material embedded in them (other than existing magnetic material). We also reserve the rights on the use as a superconductor any material even if it is already patented for other uses. And any combination of the above factors.

1. Field of Invention

This invention falls in the field of superconduction of electrical energy in a very wide range of temperatures. Specifically, the creation of materials which act as superconductors (or superconducting magnets) at temperature ranges above to below room temperature.

2. Discussion of Prior Art

No current product is available for use as a superconductor of electricity at any easily used temperatures. Some exist at temperatures ranging from roughly the temperature of liquid nitrogen to absolute zero. This makes them impractical to use in most circumstances. Our invention extends past and overlaps this temperature range, making it much easier to use in a variety of stable and changing environmental conditions. In addition, severe limitations often exist in current carrying capacity of these other products, as well as severe limitations in mechanical features such as size, flexibility, shape, sturdiness, and so on.

Our invention solves the primary problem of temperature of superconduction, as well as offering a series of advantages and tradeoffs in other characteristics.

### SUMMARY

Our main claim is in recognizing how to identify a class of materials which are potential superconductors. In addition, we claim the methods which can be used to treat or form these materials to make them into superconductors. One of the unique values of this discovery is in making room temperature superconductors.

### OBJECTS AND ADVANTAGES

This invention allows the discovery and production of superconducting material in a variety of physical forms that make them simple to use, and that will operate over a range of temperatures. Of special significance and a breakthrough from prior art is in identifying materials that can become room temperature superconductors, although a large range of conditions can be accommodated by choice of different materials.

Further objects and advantages of my invention will become apparent from a consideration of the ensuing description.

### DESCRIPTION OF INVENTION

The first part of the invention is the ability to identify superconducting material. Any processes that can detect magnetic fields in materials that have been or are being exposed to magnetic fields also identify the material as something that can be made into superconductors. The novel use of these materials as superconductors is the core of this part of the invention.

The second part of the invention is the transition of the temporary or permanent magnetic material into a superconducting material. The preferential method for making superconductors is using electrical methods, although mechanical and chemical methods might be used. Using electrical methods is done differently for permanent and temporary magnet material. For permanent magnet material, a pulsed or AC voltage at very high voltages and frequency is connected across the material to be changed. There is a range of values that can be used on any particular substance, and a variation from substance to substance.

Using electrical methods, a temporary magnet material needs to be treated differently. It is also induced into the superconducting mode by exposure to a high voltage and frequency, but the effect is maintained by coupling from an adjacent wire which is carrying a particular range of electrical signal.

### OPERATION OF INVENTION

First, the superconductors produced operate in general over approximately the range of environmental conditions that a magnetic version of the same material does. In addition, limitations of current conduction, mechanical shock or high pressure, and high temperatures exist for each material.

The operation of these superconducting materials falls into two categories. The materials that exhibit permanent magnetism, and ones that are only temporary magnets. The permanent magnetic material can be induced into superconduction and will remain in that state unless environmental conditions are violated. The temporary magnetic material needs a support in keeping it in the superconducting state, such as by an external wire.

The operation of the methods to induce superconduction vary with the method. There is an electrical method, a mechanical method, and a chemical method.

### DESCRIPTION AND OPERATION OF ALTERNATIVE EMBODIMENTS

The main types of alternative embodiments are in how to make the selected magnetic material a superconductor. One way to do this is with high pressure. Another is by doping the magnetic material with certain chemical substances to also achieve the superconductor effect.

### THEORY OF OPERATION

This patent is based on a flash of insight I had into a phenomenon of physics that has always baffled scientists—that of the existence of magnetic material. My insight was to realize magnetic materials exhibit magnetism because magnetic domains (the minimum area of magnetic action in magnetic materials) were actually composed of superconducting material in the domain walls. And that it is continuous conduction of current in the superconducting domain wall structure that creates the phenomenon of magnetic material. This effect also explains the phenomenon of the Curie temperature, which is thus the temperature that the domain walls cease to act as a superconductor. This patent expands on this fundamental insight to create products and processes based on this phenomenon.

### CONCLUSION, RAMIFICATIONS, AND SCOPE OF INVENTION

Thus, this patent covers a vary wide range of materials and processes in an area of technical endeavor that has never before been understood or utilized—that of identifying and creating an entire class of superconductors. We cover the identification and production processes and usages of this newly discovered effect in physics—that of identifying and creating superconductors at environmental conditions that include ones that are comfortable for human beings. This has been the goal of scientists all over the world ever since the superconduction effect was first discovered in the temperature ranges near absolute zero.

The materials that are described in this patent application may have advantageous mechanical properties, such as low friction.

Since this patent identifies a class of materials never before used as superconductors, and identifies processes to create the superconducting effect in them, a huge range of variations are possible: changes in size, choice of material or mixtures or combinations with other materials, choice of shapes, modifications to give the products other characteristics, such as color, density, thermal, mechanical or electrical properties, connected or associated with adjacent or additional elements in different manners used in different modes of function or operation, as in controlled partial or switched superconduction, or as a partial or switched heat energy conductor, or as a partial or switched device for its mechanical properties, made integrally or separately, modularly or in sections.

While my descriptions contain many specificities, these should not be construed as limitations on the scope of the invention, but rather as exemplification of one preferred embodiment thereof. Many other variations are possible. For example, the production of superconductors using means of pressure or chemical doping. And the use of our superconducting materials in areas other than the transmission of electricity, such as in the creation of magnetic fields, in the transmission of heat, and in the uses due to their mechanical and thermal properties. And the use of these superconducting materials as part of other materials or fabrications, such as when mixing or inserting or synthesizing superconducting materials with other materials to create new products and effects. One of the many embodiments might be in adding superconductors as filaments inside another material to change its heat or electrical or magnetic properties. And we include the use of other types of superconducting materials that does not stay permanently superconducting without outside influence or that does not exhibit perfect superconduction.

Accordingly, the scope of the invention should be determined not by the embodiments illustrated, but by the appended claims and their legal equivalents.

This invention consists of three parts: 1) recognizing what materials are superconductors or can potentially be made into superconductors, 2) recognizing how to identify atomic or molecular arrangements that will result in full, partial, or switched superconducting effect in the materials, 3) what types of processes that can be either used to induce these materials into the superconducting state or cause them to be in it from the manufacturing process. I therefore make claim on the following subject matter.

Any new manufacturing process that makes material with superconducting domain wall properties, as for new magnetic materials or in creating superconducting channels in materials.

Any material that exhibits any kind of magnetic behavior for use as a superconductor, but not restricted to this (in case there are materials that don't have a domain wall that makes a continuous loop.)

Any material that has any superconductor structures in it. (For example, filaments of superconductors in it. This allows for changing mechanical properties in the material in use, or any variation or simplification in manufacturing.

This usage to design better magnets or in other types of energy storage (thermal, electrical, magnetic). For example, a loop of the stuff becomes a large permanent magnet.

These superconductor usage as a heat conduction device, and for other uses of their mechanical properties, such as low friction.

Any partial or switched uses for the superconductors.

Any near superconductors, such as materials that exhibit not quite perfect, or not quite stable superconduction.

The foregoing claims are representative and are not intended to be exhaustive.

1. Any new manufacturing process that makes material with superconducting domain wall properties, as for new magnetic materials or in creating superconducting channels in materials.

2. Any material that exhibits any kind of magnetic behavior for use as a superconductor, but not restricted to this (in case there are materials that don't have a domain wall that makes a continuous loop.)

3. Any material that has any superconductor structures in it. (For example, filaments of superconductors in it. This allows for changing mechanical properties in the material in use, or any variation or simplification in manufacturing.
